(19) United States
(12) Patent Application Publication
(10) Pub. No.: US 2002/0061737 A1
(43) Pub. Date: May 23, 2002

(54) Process and device for the frequency clamping of a radio signal receiver

(76) Inventors: Gaston Laurens, Le Cheylas (FR); Laurent Cariou, Meylan (FR)

Correspondence Address: YOUNG & THOMPSON, 745 SOUTH 23RD STREET 2ND FLOOR, ARLINGTON, VA, 22202

(21) Appl. No.: 09/985,566

(22) Filed: Nov. 5, 2001

(30) Foreign Application Priority Data
Nov. 3, 2000 (FR) 00 14132

(51) Int. Cl. H04B 1/18

(52) U.S. Cl. 455/161.1; 455/255

(57) ABSTRACT

Process and device for receiving radio signals include a receiver having an antenna and a reception circuit exhibiting a received-signal output. Sampling elements make it possible to endow the receiver with reception phases separated by phases of absence of reception. Adjustment elements make it possible to operate the reception circuit on particular frequencies of operation. A generator delivers a reference signal on a nominal frequency. Sensors act on the adjustment elements so that the reception circuit operates, during a sensing period, successively on frequencies including the nominal frequency. Drive elements divide the sensing period into sensing phases (Ps), the duration of each of which is at most equal to the duration of the phases of absence of reception of the reception circuit and actuate the signals generator and the sensors during these sensing phases. Detectors detect the amplitude of the signal appearing at the output of the reception circuit during the sensing phases; and elements act on the adjustment elements so as to fix a new frequency of operation of the reception circuit.

A subject of the present invention is a process and a device for the frequency clamping or adjustment of a radio signal receiver.

At present, the clamping or adjustment of the tuning frequency of a radio signal receiver is carried out either with the aid of components which can be trimmed during manufacture or automatically in the course of the use thereof by using a reference frequency originating from an emitter whose stability corresponds to the desired accuracy of clamping.

In the first case, the ageing of the receiver and the variations in the characteristics of its constituent components, which are due in particular to variations in temperature and in hygrometry at the location where this receiver is installed, give rise to variations in its tuning frequency with respect to the tuning frequency adjusted during manufacture.

In the second case, the receiver is periodically placed in clamping periods during which it is no longer able to receive outside signals.

The present invention aims to remedy the abovementioned drawbacks.

The subject of the present invention is firstly a process for the frequency clamping of a radio signal receiver comprising an antenna and a reception circuit exhibiting a received-signal output, in which sampling means make it possible to endow the reception circuit with reception phases separated by phases of absence of reception of radio signals.

The process according to the invention consists:

in operating the receiver on a particular reception frequency in the course of the said reception phases;

in generating a sensing period divided into sensing phases included within phases of absence of reception of the reception circuit and in delivering a reference signal, emitted on a nominal frequency, to the input of the reception circuit during these sensing phases;

in varying, in the course of the said sensing phases, the frequency of operation of the reception circuit and in detecting the amplitude of the sensing signal appearing at the output of the reception circuit;

in fixing a new frequency of operation of the said reception circuit corresponding to an amplitude of the sensing signal;

in placing the reception circuit on this new particular frequency of operation in the course of a subsequent phase of absence of reception of this reception circuit and in operating the receiver on this new particular reception frequency in the course of its subsequent periods of reception.

The process according to the invention can advantageously consist in fixing a new frequency of operation of the said reception circuit corresponding to the frequency for which the amplitude of the sensing signal is a maximum or close to its maximum.

The process according to the invention can advantageously consist in disconnecting the antenna from the reception circuit in the course of the said sensing phases and in connecting to this reception circuit a generator of the reference signal at the aforesaid nominal frequency.

A subject of the present invention is also a device for receiving radio signals comprising a receiver comprising an antenna and a reception circuit exhibiting a received-signal output, sampling means making it possible to endow the receiver with reception phases separated by phases of absence of reception.

According to the invention, this device comprises:

means of adjustment making it possible to operate the reception circuit on particular frequencies of operation;

a generator of a reference signal on a nominal frequency;

sensing means adapted to act on the means of adjustment so that the reception circuit operates, during a sensing period, successively on frequencies of a frequency band including the nominal frequency;

drive means dividing the sensing period into sensing phases, the duration of each of which is at most equal to the duration of the phases of absence of reception of the said reception circuit and actuating the signals generator and the sensing means during these sensing phases;

means of detection for detecting the amplitude of the signal appearing at the output of the reception circuit during the sensing phases;

and means acting on the said means of adjustment so as to fix a new frequency of operation of the said reception circuit corresponding to an amplitude of the sensing signal.

The device according to the invention can advantageously comprise means of connection/disconnection, subjected to the said drive means so as to disconnect the antenna from the reception circuit and connect the reference signal generator to this reception circuit during the sensing phases.

According to the invention, the said means of connection/disconnection preferably comprise a switch with two pathways.

According to the invention, the said means of adjustment preferably comprise a variable-capacitance capacitor.

The device according to the invention can advantageously comprise means for cutting/establishing the supply to the reception circuit, these means being subjected to the said drive means so as to establish or maintain the supply to the reception circuit during the aforesaid sensing phases.

The present invention will be better understood on studying devices for the frequency clamping of radio signal receivers and their operating processes, described by way of non-limiting examples and illustrated by the drawing in which:

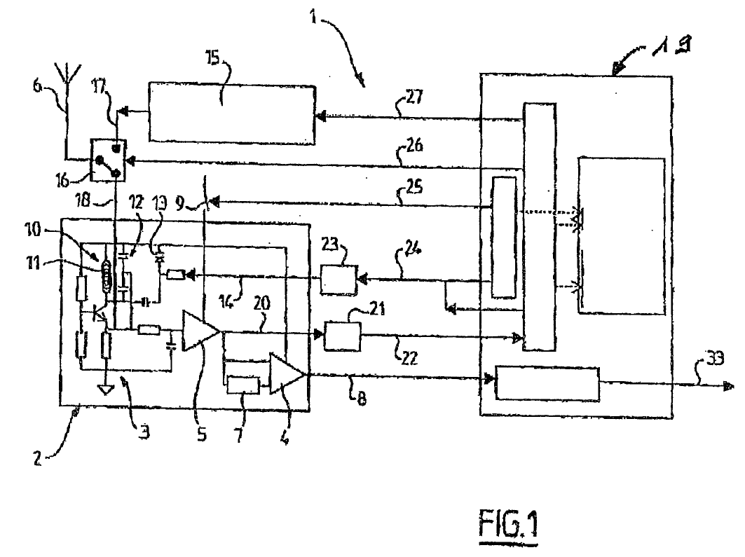

FIG. 1 represents a device for receiving radio signals including a super-regenerative reception circuit;

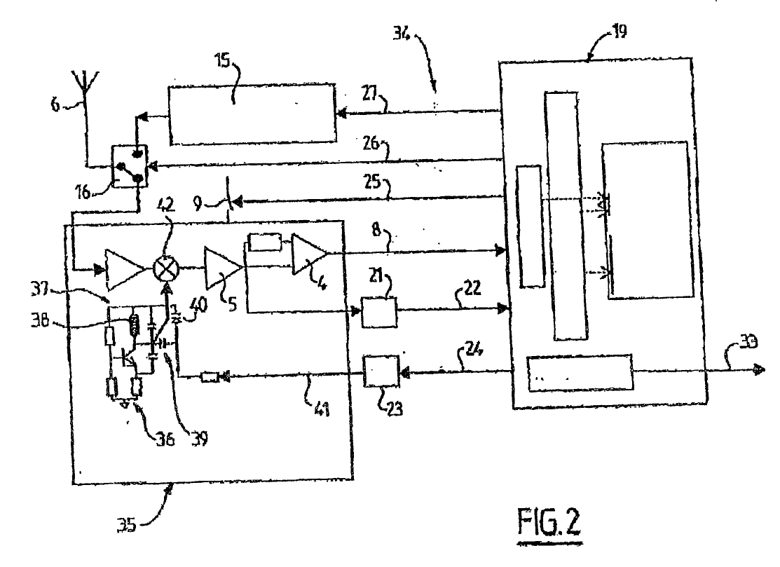

FIG. 2 represents the electronic diagram of a device for receiving radio signals including a super-heterodyne reception circuit;

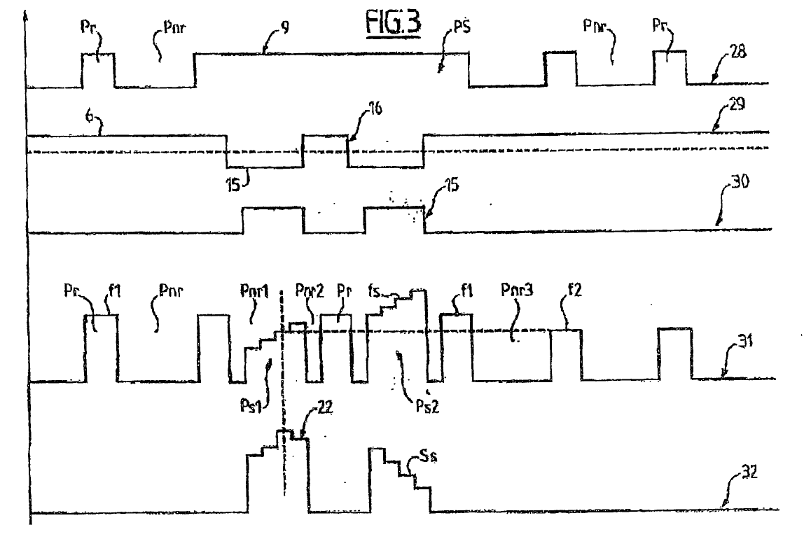

and FIG. 3 represents a flow chart of the operation of the aforesaid devices.

Referring to FIG. 1, one can see that represented therein is a radio signal reception device 1 which includes a super-regenerative receiver 2.

This super-regenerative receiver 2 comprises a super-regenerative oscillator circuit 3 capable of delivering to an input of a comparator 4, via an amplifier 5, a signal representative of a radio signal picked up by an antenna 6, the other input of the comparator 4 being subjected to a threshold 7 such that the comparator 4 delivers a digital signal on the received-signal output 8 of the reception circuit 2.

The reception circuit 2 is capable of being supplied from an electrical energy source (not represented), the (+) pole of this supply being linked to the reception circuit by way of a controllable breaker 9.

The super-regenerative oscillator 3, constructed moreover in a customary manner and configured in the example represented in external quench mode, comprises a stopper circuit 10 which comprises, arranged in parallel, a choke 11 and an arrangement 12 of capacitors.

In a manner known per se, the frequency of oscillation of the super-regenerative oscillator circuit 3, and consequently the frequency of operation of the reception circuit 2, are determined mainly by the characteristics of the stopper circuit 12.

In order to be able to vary and adjust this frequency of operation, the capacitor arrangement 12 comprises a variable-capacitance capacitor 13 voltage-controlled via an input line 14 of the reception circuit 2.

The reception device 1 furthermore comprises a generator 15 adapted so as to deliver to the reception circuit 2, via a wire line, a reference signal on a specified nominal frequency corresponding to the frequency on which radio signals are expected to be picked up by the antenna 6.

In order to selectively link the antenna 6 and the generator 15 to the reception circuit 12, the reception device 1 comprises a controllable switch 16. To do this, the antenna 6 is linked to one of the contact points of the switch 16, the output of the generator 15 is linked to the other contact point of the switch 16 by a line 17 and the common point of the amplifier 16 is linked to the super-regenerative oscillator 3 by a line 18.

The reception device 1 furthermore comprises an electronic digital signal processing and drive unit 19 mounted as follows.

The electronic unit 19 comprises an input to which is wired the line 8 emanating from the received-signal output of the comparator 4.

The output of the amplifier 5 is linked to an output of the reception circuit 2 by a line 20 which is linked to the input of an A/D (analogue/digital) conversion circuit 21 whose output is linked to an input of the electronic unit 19 by a sensing line 22.

An output for adjusting the electronic unit 19 is linked to an input of a D/A (digital/analogue) converter 23 by a line 24, the output of this D/A converter 23 being linked to the voltage-control line 14 of the variable capacitor 13.

A control output of the electronic unit 19 is linked to the control input of the breaker 9 by a line 25.

A control output of the electronic unit 19 is linked to the control input of the switch 16 by a line 26.

A control output of the electronic unit 19 is linked to the control input of the generator 15 by a line 27.

Referring to FIGS. 1 and 3, the manner in which the reception device 1 operates will now be described.

To do this, it may be seen that FIG. 3 represents an operating chart 28 for the breaker 9, an operating chart 29 for the switch 16, an operating chart 30 for the generator 15, an operating chart 31 for the reception circuit 2 and a chart 32 for the sensing signals delivered to the electronic unit 19 by the line 22.

During standard operation, the electronic unit 19 delivers via the line 24 a constant adjusting signal to the D/A converter 23 whose output imposes a specified voltage on the variable-capacitance capacitor 13 thereby fixing a specified frequency of operation f1 of the super-regenerative oscillator circuit 3 and consequently of the reception circuit 2.

In order in particular to reduce the electrical energy consumption, the electronic unit 19 controls the breaker 9 in such a way as to generate reception phases Pr during which the breaker 9 is placed in the closed position so that the reception circuit 2 is supplied with electrical energy, separated by phases of absence of the reception Pnr during which the reception circuit 2 is not supplied with electrical energy.

In the course of these standard phases visible in the charts 28 and 31, the electronic unit 19 controls the switch 16 in such a way as to link the antenna 6 to the super-regenerative oscillator circuit 3.

As the generator 15 is out of service during these standard phases, the electronic unit 19 could control the switch 16 in such a way as to disconnect the antenna 6 from the reception circuit 2 during the phases of absence of reception Pnr so as to reduce any re-emissions by the antenna 6.

In the course of the reception phases Pr, the electronic unit 19 analyses the signals emanating from the comparator 4 on the line 8, which are representative of the radio signals picked up by the antenna 6, and may deliver control signals via an output line 33.

At relatively spaced specified moments, the electronic unit 19 generates sensing periods PS making it possible to analyse the functional state of the reception circuit 2 and in particular of the super-regenerative oscillator circuit 3, the duration of each sensing period being larger than the duration of each phase of absence of reception Pnr.

To do this, in the example described, the electronic unit 19 divides the sensing period PS into two sensing phases Ps1 and Ps2, the duration of each of which is less than the duration of each phase of absence of reception Pnr so as thus to be includable within two successive phases of absence of reception Pnr1 and Pnr2 as shown by the chart 31.

In the course of this sensing period PS, the electronic unit 19 keeps the breaker 9 in its closed position so as to maintain the supply to the reception circuit 2 during the phases of absence of reception Pnr1 and Pnr2 and consequently throughout the sensing period as shown by the chart 28.

During the sensing phases Ps1 and Ps2 included, in the example described, within two successive phases of absence of reception Pnr1 and Pnr2, the electronic unit 19 operates as follows.

As shown by the chart 29, the electronic unit 19 controls the switch 16 in such a way as to link the generator 15 to the super-regenerative oscillator circuit 3 by the lines 17 and 18.

As shown by the chart 30, the electronic unit 19 puts this generator 15 into operation so that the reference signal at a specified nominal frequency, delivered by this generator 15, invokes the reception circuit 2 via the switch 16.

As shown by the chart 31, the electronic unit 19 controls the D/A converter 23 in such a way that the latter delivers adjustment signals Sr which cause the control voltage of the variable-capacitance capacitor 13 to vary stepwise and consequently cause the frequency of operation of the reception circuit 2 to vary according to sensing frequencies fs which include the aforesaid nominal frequency.

At the same time, the electronic unit 19 analyses the amplitude of the sensing signal Ss communicated to it by the A/D converter 21 via the line 22 and which emanates from the super-regenerative oscillator circuit 3 via the amplifier 5.

The electronic unit 19 then searches for the value of the adjustment signal Srm for which the amplitude of the sensing signal Ss is a maximum or approximately a maximum.

Starting from the next phase of absence of reception Pnr 3 and up to the next sensing period PS, the electronic unit 19 delivers the new adjustment signal Srm to the D/A converter 23 in such a way that the latter places the reception circuit 2 on the new frequency of operation f2 associated with the new control voltage for the capacitance of the variable-capacitance capacitor 13.

Of course, the sensing period PS could be divided into more than two sensing phases Ps, included within as many phases of absence of reception Pnr as necessary as a function of the number of sensing frequencies fs applied and of the duration of their application. These sensing phases Ps could be followed moreover by a sensing phase having reduced steps so as to refine the value of the adjustment signal Sr for the new frequency of operation f2 to be applied.

It follows from what has just been described that the sensing period PS divided into sensing phases Ps included within the phases of absence of reception Pnr of the reception circuit 2 does not disturb the reception capabilities of the reception circuit 2.

Specifically, the reception circuit 2 continues to exhibit reception phases Pr during the sensing period Ps such that signals picked up by the antenna 6 during this sensing period PS in the course of the reception phases Pr included within this sensing period PS are capable of being received and processed by the electrical unit 19.

Referring to FIG. 2, one can see that represented therein is a reception device 34 which differs from the reception device described with reference to FIG. 1 solely by the fact that it comprises a super-heterodyne reception circuit 35 of general structure known per se.

This reception circuit 35 comprises an oscillator circuit 36 whose frequency of oscillation is also determined by a stopper circuit 37 which comprises a choke 38 and an arrangement 39 of capacitors which includes a variable-capacitance capacitor 40 voltage-controlled via a line 41 linked to the output of the D/A converter 23.

The signal emanating from the local oscillator 36 and the signal emanating from the antenna 6 or from the generator 15 via the switch 16 are delivered to a mixer 42 whose output is linked, as in the previous example, to the amplifier 5 whose output is linked on the one hand to the line 8 via the comparator 4 and on the other hand to the input of the A/D converter 21

The reception device 34 can thus operate in the same manner as the reception device 1, so that the electronic unit 19 can drive the control voltage of the variable-capacitance capacitor 40 so as to periodically adjust the frequency of operation of the super-heterodyne reception circuit 35, without disturbing its reception phases.

The present invention is not limited to the reception devices 1 and 34 described above. Many variant embodiments are possible, in particular as regards the structure proper of the reception circuits, known per se, which could depend on the radio signals to be received and on the requirements of processing by the electronic unit 19 of the corresponding signals received. Furthermore, the facility making it possible to vary and to adjust their frequency of operation could be different.

1. Process for the frequency clamping of a radio signal receiver comprising an antenna and a reception circuit exhibiting a received-signal output, in which sampling means make it possible to endow the reception circuit with reception phases separated by phases of absence of reception of radio signals, characterized in that it consists:
in operating the receiver on a particular reception frequency (f1) in the course of the said reception phases (Pr);
in generating a sensing period (PS) divided into sensing phases (Ps) included within phases of absence of reception (Pnr) of the reception circuit (2) and in delivering a reference signal, emitted on a nominal frequency, to the input of the reception circuit during these sensing phases;
in varying, in the course of the said sensing phases, the frequency of operation of the reception circuit (2) and in detecting the amplitude of the sensing signal (Ss) appearing at the output of the reception circuit;
in fixing a new frequency of operation (f2) of the said reception circuit corresponding to an amplitude of the sensing signal;
in placing the reception circuit on this new particular frequency of operation in the course of a subsequent phase of absence of reception of this reception circuit and in operating the receiver on this new particular reception frequency in the course of its subsequent periods of reception.

2. Process according to claim 1, characterized in that it consists in fixing a new frequency of operation (f2) of the said reception circuit (2) corresponding to the frequency for which the amplitude of the sensing signal is a maximum or close to its maximum.

3. Process according to one of claims 1 and 2, characterized in that it consists in disconnecting the antenna (6) from the reception circuit in the course of the said sensing phases and in connecting to this reception circuit a generator (15) of the reference signal at the aforesaid nominal frequency.

4. Device for receiving radio signals comprising a receiver comprising an antenna and a reception circuit exhibiting a received-signal output, sampling means making it possible to endow the receiver with reception phases separated by phases of absence of reception, characterized in that it comprises:
means of adjustment (13) making it possible to operate the reception circuit (2) on particular frequencies of operation;
a generator (15) of a reference signal on a nominal frequency;
sensing means (19, 22, 23) adapted to act on the means of adjustment so that the reception circuit operates, during a sensing period, successively on frequencies including the nominal frequency;
drive means (19, 23) dividing the sensing period into sensing phases (Ps), the duration of each of which is at most equal to the duration of the phases of absence of reception of the said reception circuit and actuating the signals generator and the sensing means during these sensing phases;
means of detection (21) for detecting the amplitude of the signal appearing at the output of the reception circuit during the sensing phases;
and means (19) acting on the said means of adjustment so as to fix a new frequency of operation of the said reception circuit corresponding to an amplitude of the sensing signal.

5. Device according to claim 4, characterized in that it comprises means of connection/disconnection (16), subjected to the said drive means so as to disconnect the antenna from the reception circuit and connect the reference signal generator to this reception circuit during the sensing phases.

6. Device according to claim 5, characterized in that the said means of connection/disconnection comprise a switch with two pathways (16).

7. Device according to any one of claims 4 to 6, characterized in that the said means of adjustment (13) comprise a variable-capacitance capacitor.

8. Device according to any one of claims 4 to 7, characterized in that it comprises means (9) for cutting/establishing the supply to the reception circuit, these means being subjected to the said drive means so as to establish or maintain the supply to the reception circuit during the aforesaid sensing phases.
